(19) United States
(12) Patent Application Publication
(10) Pub. No.: US 2002/0143696 A1
(43) Pub. Date: Oct. 3, 2002

(54) Methods and systems for financing

(76) Inventors: Eleanor S. Wilson, Westport, CT (US); Simon R. Duncan, Stamford, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,412

(22) Filed: Mar. 30, 2001

(51) Int. Cl. G06F 17/60

(52) U.S. Cl. 705/38; 705/35

(57) ABSTRACT

Methods and systems for operating a computer to facilitate financing inquiries about possible financing transactions are described. The method includes the steps of prompting a customer to select a financing type or prompting the customer to provide background information related to a financing requirement and providing the customer with a recommended financing product. The system is, in the exemplary embodiment, accessible to the customer via a network such as a wide area network, for example, an extranet accessible via the Internet, so that the customer can query the database and identify financing types that meet specific requirements.

### BACKGROUND OF INVENTION

This invention relates generally to methods and systems for facilitating financing transactions and more particularly to methods and systems for facilitating customer initiation and selection of a financing product.

Operators sometime determine that it is more economical to finance a facility using a different financing type than their existing financing . For example, operators of a power generation plant which is financed through a conventional mortgage type note sometimes determine that giving an equity stake to another entity is better.

For example, a purchaser of an equity stake, may be able to find purchasers of energy that current operators have been unable to locate, thereby operating the plant closer to maximum output, and theoretically, at maximum profit. However, finding potential purchasers of equity stakes, or providers of other types of financing is expensive and time consuming.

### SUMMARY OF INVENTION

Systems and methods that facilitate both customer and lender productivity from selection of particular financing types for facilities are provided herein. In one exemplary embodiment, the system includes a server having a database for storing data relating to evaluations of facilities. The stored data includes background information relating to the facility or facilities where financing is desired, as well as financing specific information for each facility. The system is accessible to the customer via a network such as a wide area network, e.g., an extranet accessible via the Internet, so that the customer can query and identify financing types that meet specific customer needs.

More specifically, once a customer accesses the system, the system prompts the customer, e.g., via an electronic interface, to enter information relating to a type of financing desired. The customer is prompted, through the electronic interface, to provide background information related to a financing requirement, and finally, based upon customer entered information, a financing product is recommended to the customer. Once a financing product has been recommended, if the customer is interested in further pursuit of financing, based upon the recommendation, the customer inputs data into the system to initiate further contact regarding the financing opportunity.

In another aspect, a computer is programmed to prompt a customer to provide information related to a financing requirement, determine a proper financing product for the customer and prompt the customer with an inquiry as to whether they wish to pursue financing opportunities.

In other aspects, a database is provided which includes data corresponding to answers to questions relating to a financing requirement and data corresponding to a recommended financing type for the customer. A computer-readable medium is provided which includes records of customer submitted facility data, a plurality of rules for applying the data to determine an equity valuation and records of results from applying the rules to the facility data.

### BRIEF DESCRIPTION OF THE DRAWINGS

FIG. 1 is a flowchart diagramming customer steps.

FIG. 2 is a simplified system diagram.

FIG. 3 is a diagram of an exemplary networked system.

FIG. 4 is a flow chart illustrating process steps for,facilitating a financing inquiry.

FIG. 5 is an exemplary screen shot of a home page for facilitating financing transactions.

FIG. 6 is an exemplary screen shot of a background questions page.

FIG. 7 is an exemplary screen shot of a financing specific page.

FIG. 8 is an exemplary screen shot describing a project finance product.

FIG. 9 is an exemplary screen shot describing a high yield debt financing product.

FIG. 10 is an exemplary screen shot describing a leasing financing product.

FIG. 11 is an exemplary screen shot describing a project common equity financing product.

FIG. 12 is an exemplary screen shot describing a limited partnership financing product.

FIG. 13 is an exemplary screen shot describing a private equity financing product.

FIG. 14 is an exemplary screen shot describing a preferred equity financing product.

FIG. 15 is an exemplary screen shot showing an interface to an equity valuation tool.

FIG. 16 is a continuation of the screen shot of FIG. 15.

FIG. 17 is an exemplary embodiment of a screen shot showing results of an equity valuation.

FIG. 18 is an exemplary embodiment of a screen shot where a customer can request to be contacted regarding financing opportunities.

### DETAILED DESCRIPTION

Set forth below is a description of exemplary methods and systems for facilitating financing transactions. While the methods and systems are sometimes described in the context of financing for power plants and other power generating facilities, the methods and systems are not limited to practice in connection with only power generation. The methods and systems can be used, for example, in connection with financing for refineries, mines, pipelines, factories, warehouses, and many other different types of infrastructure financing.

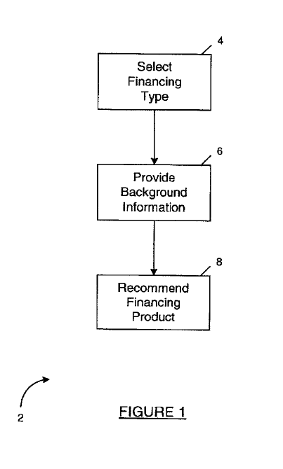

FIG. 1 is a flow chart 2 illustrating process steps for facilitating a financing inquiry regarding a project or an opportunity for which financing is desired, using a system configured for facilitating financing. In one exemplary embodiment, a customer accesses system and the system prompts the customer, to select 4 a financing type relating to a type of site, for example, a power plant. Financing options include, but are not limited to, leasing, an extension of equity, or a partnership. Available financing options are explained in further detail below. Of course, the system is not limited to any one specific type of financing transaction. Once the customer inputs a selection 4 of the financing type sought, the system then obtains information, e.g., via a display that prompts the customer to provide 6 background information based on the facility for which the financing is desired. The information required by the system is dependent upon the specific type of financing desired. Once the background information has been provided 6, a financing product is recommended 8.

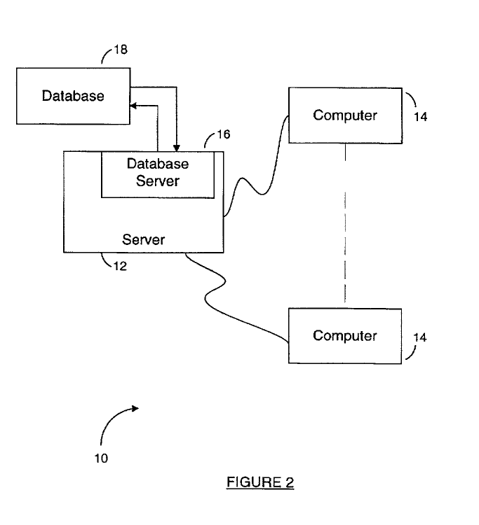

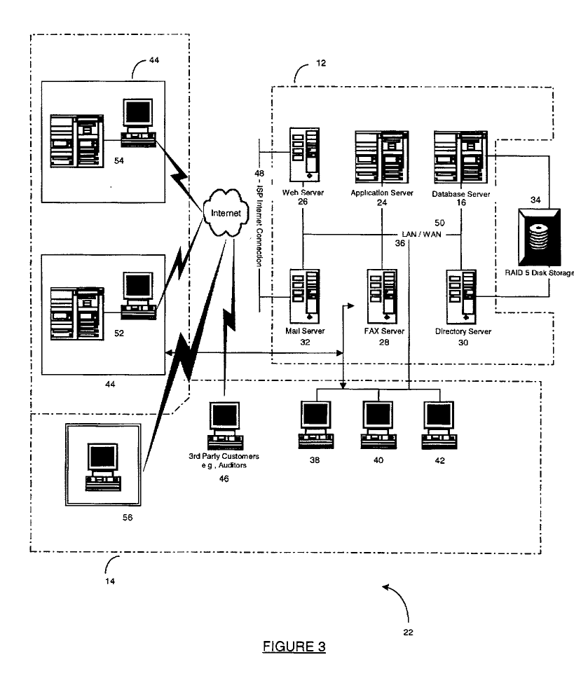

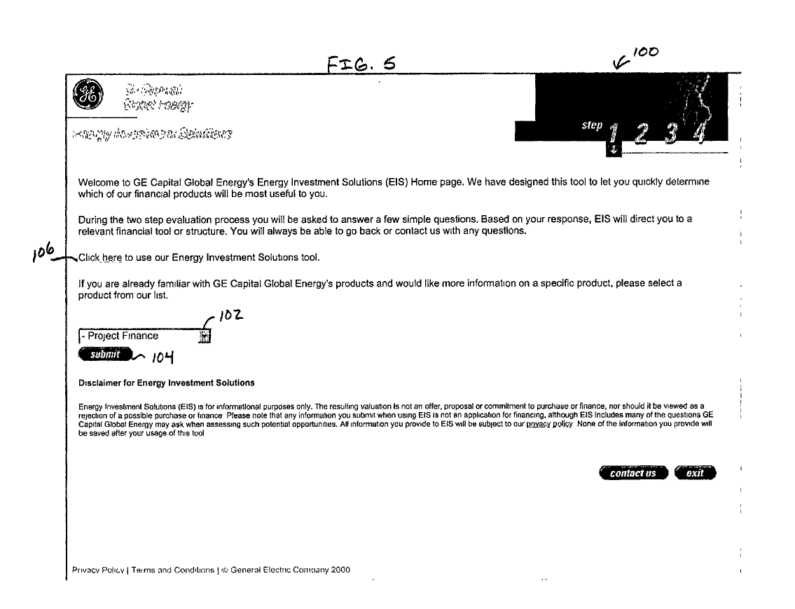

Set forth below are details regarding exemplary hardware architectures (FIGS. 2 and 3) and exemplary screen shots displayed by the exemplary system to a customer determining whether financing is to be pursued (FIGS. 5 18). Although specific exemplary embodiments of methods and systems for facilitating financing for facilities are described herein, the methods and systems are not limited to such specific exemplary embodiments.

### Hardware Architecture

FIG. 2 is a block diagram of a system 1 0 that includes a server sub-system 12, sometimes referred to herein as server 12, and a plurality of customer devices 14 connected to server 12. In one embodiment, devices 14 are computers including a web browser, and server 12 is accessible to devices 14 via a network such as an intranet or a wide area network such as the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone or other web-based connectable equipment. Server 12 includes a database server 16 connected to a centralized database 18. In one embodiment, centralized database 18 is stored on database server 16 and is accessed by potential customers at one of customer devices 14 by logging onto server sub-system 12 through one of customer devices 14. In an alternative embodiment centralized database 18 is stored remotely from server 12.

FIG. 3 is a block diagram of a network based system 22. System 22 includes server sub-system 12 and customer devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various individuals or employees 44 and to third parties, e.g., customer, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or customer 46 having a work station 52 can access server sub-system 12. One of customer devices 14 includes a work station 54 located at a remote location. Work stations 52 and 54 are personal computers including a web browser. Also, work stations 52 and 54 are configured to communicate with server sub-system 12. Furthermore, fax server 28 communicates with employees 44 and customers 46 located outside the business entity and any of the remotely located customer systems, including a customer system 56 via a telephone link. Fax server 28 is configured to communicate with other work stations 38, 40, and 42 as well.

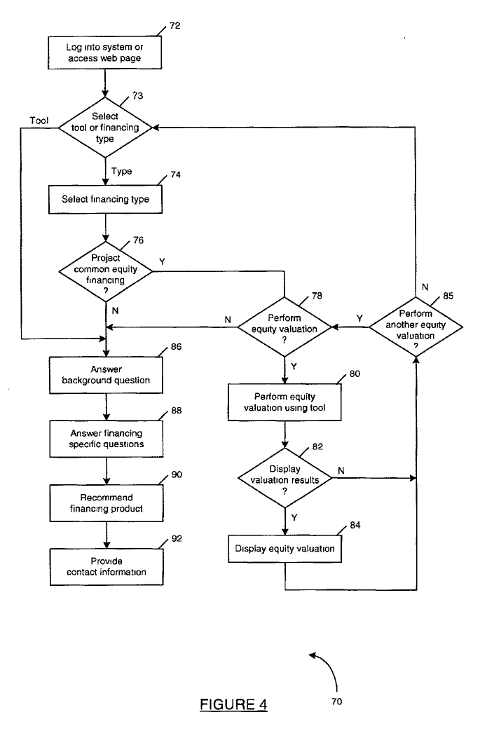

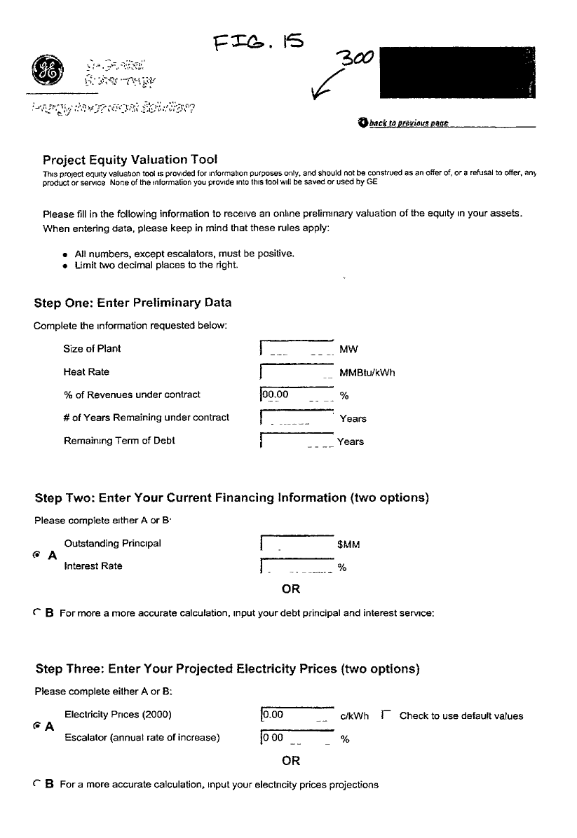

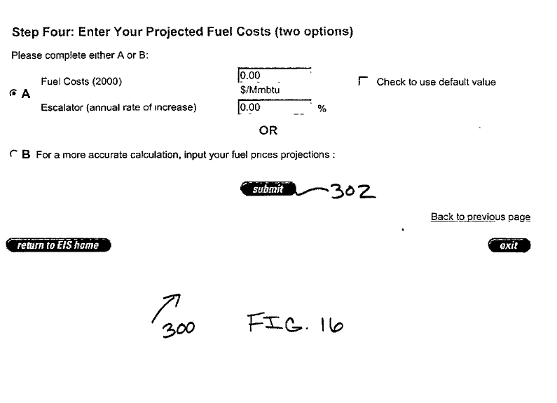

FIG. 4 is a flow chart 70 illustrating process steps for facilitating a financing inquiry regarding a power generation site. Flowchart 70 further includes process steps relating to using an equity valuation tool for use in determining financing options. In one exemplary embodiment, a customer accesses 72 system and the system prompts the customer, to select 73 a financing type or an energy solutions tool. If the customer inputs a selection 73 of a financing type, a query is performed 76, and if the financing type selection is a project common equity selection, the customer is prompted 78 to input whether an equity valuation is desired. If an equity valuation is desired, an equity valuation is performed 80 using an equity valuation tool which bases the equity valuation on customer input to questions (See FIGS. 15 and 16 below). After the valuation is completed, the customer is queried 82 whether to display 84 the valuation results. Whether or not the valuation is displayed 84, the customer has an option to perform 85 another equity valuation or return to the prompt to select 73 a financing type or energy solutions tool.

When the query is performed 76, and the financing type selection is not a project common equity selection, or if the customer originally selected the energy solutions tool, the customer is prompted 86 to provide background information based on the facility for which the financing is desired. Next, the customer is prompted to answer 88 financing specific questions. Once answers to the financing specific questions have been provided, a financing product is recommended 90. After a financing product recommendation 90, if the customer is interested in pursuing financing, the customer is prompted 92 to provide contact information so that they can be contacted by a financing company representative.

To implement the process described above, many variations of particular screens viewable by a customer can be utilized. The following description refers to one set of screens that can be used to prompt a customer to make the necessary inputs to enable the system to recommend a financing for the customer's particular facility. Of course, many variations of such screens are possible.

Referring now again specifically to the drawings, FIG. 5 is an exemplary screen shot 100 of a home page for facilitating financing transactions. Once the customer logs into system 10 (shown in FIG. 2), or alternatively accesses a web page, the system displays screen shot 100 as shown in FIG. 5. The customer can then select specific financing types using pull-down menu 102. Once a financing type is selected, the customer instructs system 10 of their selection by submitting the financing type selection to the system. In one embodiment, financing type selections available to a customer include financing project, high yield debt, leasing, project common equity, limited partnership, private equity and preferred equity. In the embodiment shown in FIG. 5, submission of a financing type is accomplished by selecting a button 104 labeled submit. Also in the embodiment shown in FIG. 5, screen shot 100 includes a link 106 to a tool, where a customer can provides answers to questions regarding the financing requirement as described below.

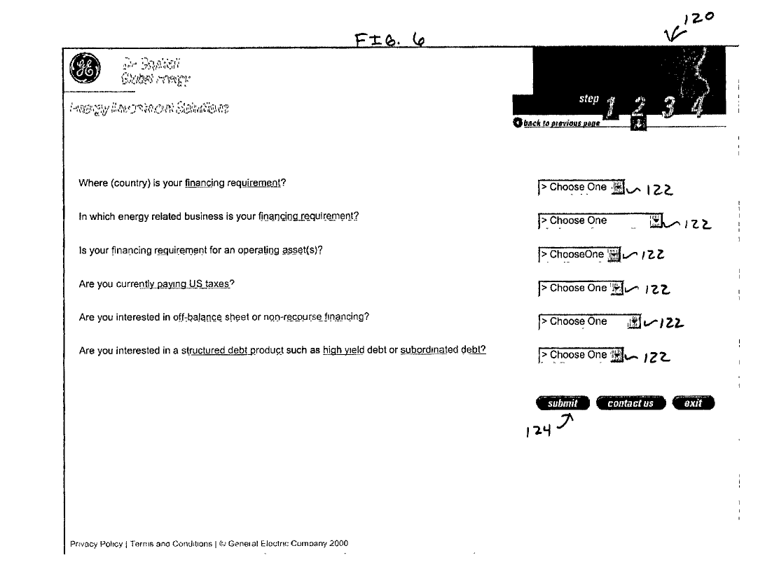

If the customer has selected link 106 as described above, then screen 120 as shown in FIG. 6 is displayed. Specifically, the customer is presented with a screen listing a number of background questions regarding the customer's financing requirement. Each question includes a drop down box 122, where the customer can select the answer to the individual background questions. In the embodiment shown, background questions include the country where financing is required, which energy related business is the financing for, is the financing required for an operating asset, are U.S. taxes currently being paid by the customer, is the customer interested in either of off-balance sheet or non-recourse financing, and is the customer interested in structured debt such as high yield debt or subordinated debt. In the embodiment shown, several of the terms in the questions include embedded links, that the customer can select, whereupon system 10 will cause a screen (not shown) which includes a definition of the term selected.

If a customer enters a negative answer to both the off-balance sheet/non-recourse financing question and the structured debt question, system 10 will cause a screen (not shown) to be displayed on which a customer can supply an answer to whether he is representing a company in the early stages of the corporate cycle without an established EBITDA or an early stage pre-IPO energy technology/services company. Also a question is presented in such a screen as to whether the customer is interested in a financing that is senior to common equity and debt-like in terms, but junior to all lenders and trade creditors.

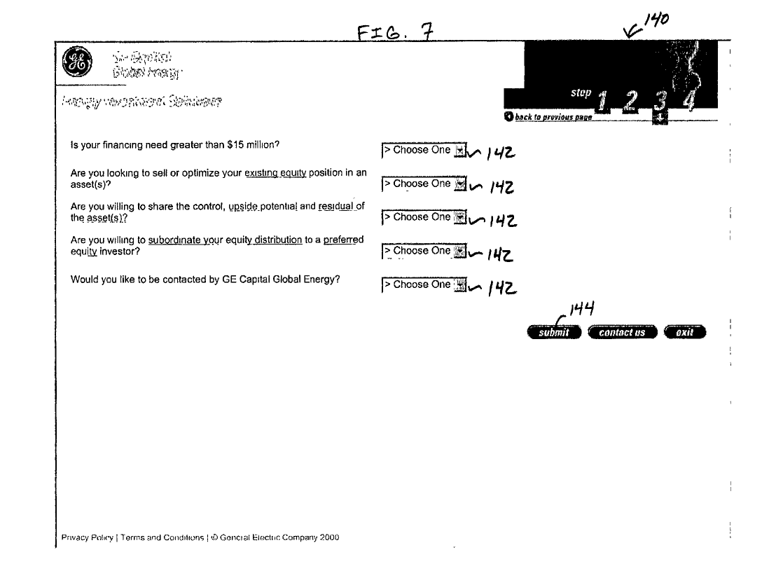

Once a customer has supplied an answer to the background questions, submission of those answers is accomplished by selecting a button 124 labeled submit. Submission of answers to background questions causes system 10 to display a screen of financing specific questions regarding the financing requirement. FIG. 7 is one embodiment of a screen 140 which includes specific questions, based upon customers responses entered into screen 120 (shown in FIG. 6), regarding a financing requirement. In the embodiment shown in FIG. 7, financing specific questions include amount of financing, selling or optimizing equity position, willing to share control, upside potential and residuals of the asset, willing to subordinate equity distribution to a preferred equity investor and willing to be contacted regarding the financing requirement. As in screen 120 (shown in FIG. 6), the embodiment shown in screen 140, has answers to financing specific questions entered using pull down menus 142 and submission of answers through use of a submit button 144. Also as in screen 120, screen 140 includes embedded links, that the customer can select, whereupon system 10 will cause a screen (not shown) which includes a definition of the term selected.

As stated above, in one embodiment, financing type selections available to a customer include project finance , high yield debt, leasing, project common equity, limited partnership, private equity and preferred equity. FIGS. 7-13 are exemplary screen shots which are displayed to a customer when a financing type has been determined and selected, and answers to the background questions and financing specific questions have been submitted to system 10 to explain the financing types.

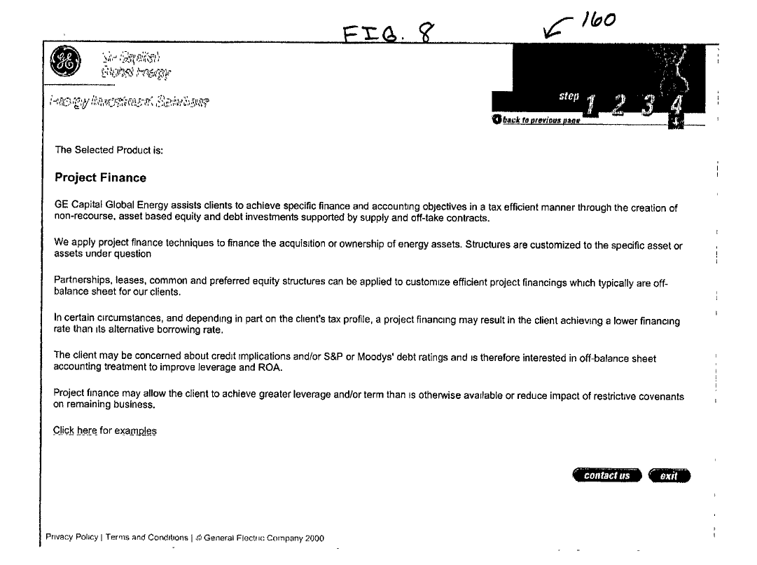

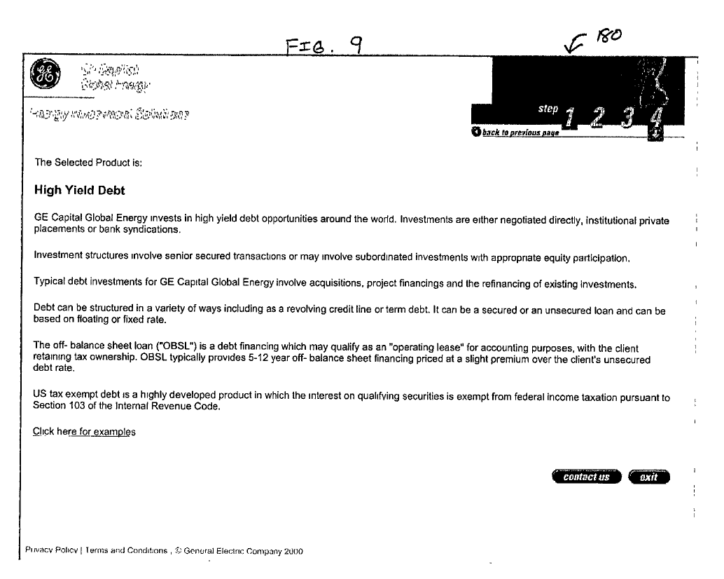

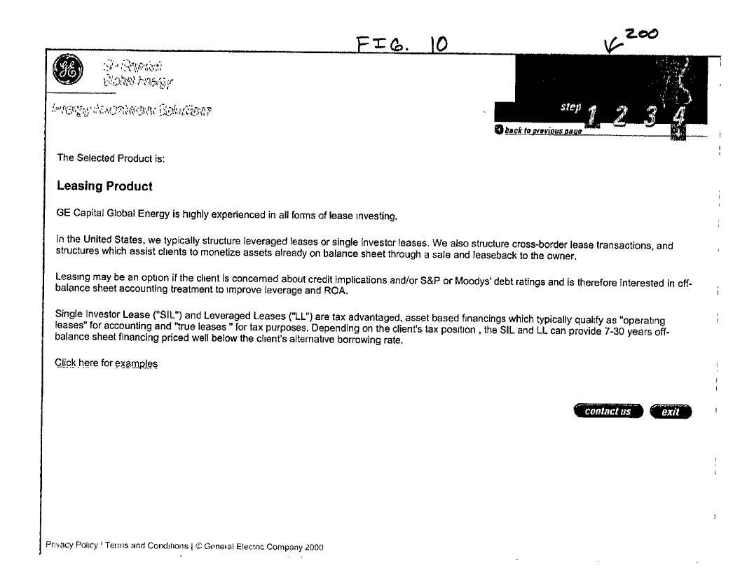

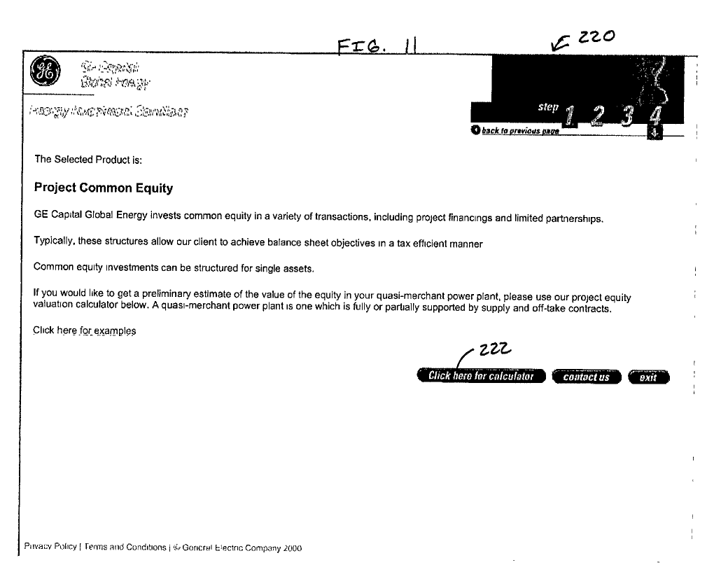

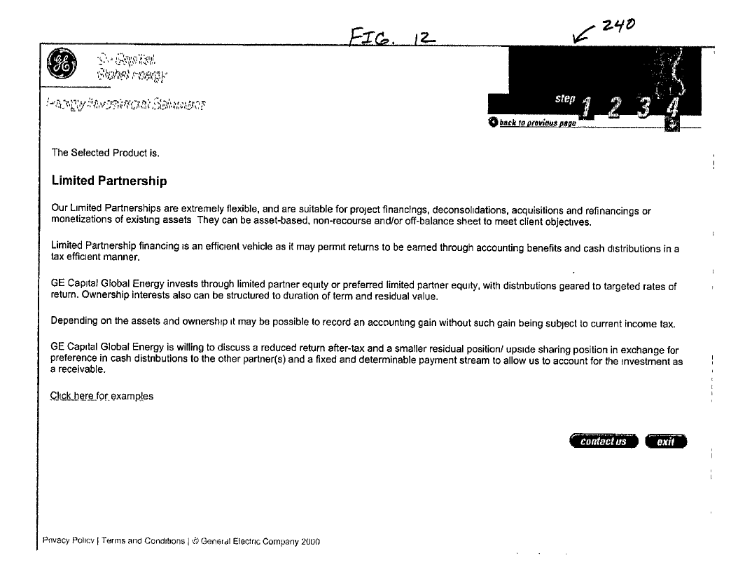

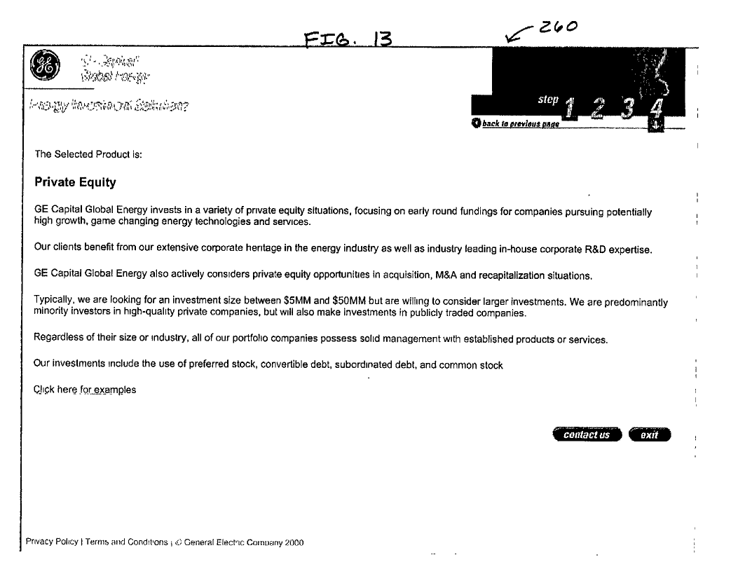

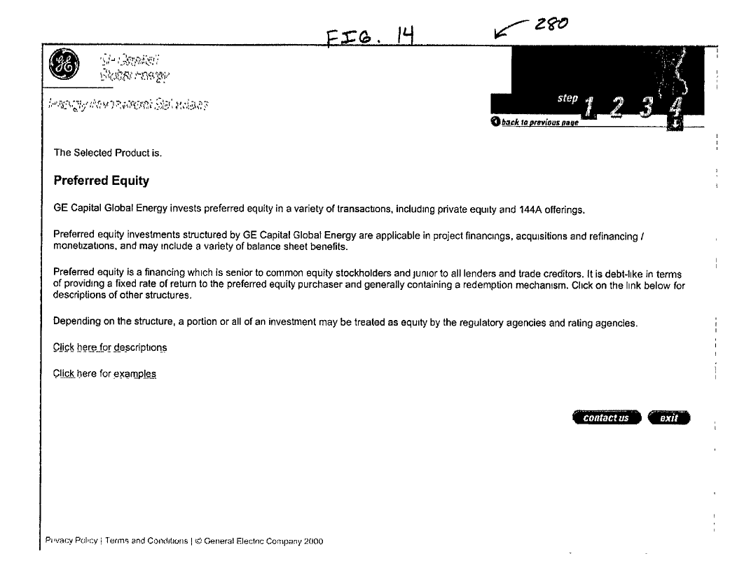

FIG. 8 is a screen shot 160 describing a project finance product. FIG. 9 is a screen shot 180 describing a high yield debt financing product. FIG. 10 is a screen shot 200 describing a leasing product. FIG. 11 is a screen shot 220 describing a project common equity financing product. FIG. 12 is a screen shot 240 describing a limited partnership financing product. FIG. 13 is a screen shot 260 describing a private equity financing product. FIG. 14 is a screen shot 280 describing a preferred equity financing product. Referring specifically to FIG. 10, screen shot 220 includes a link 222 to a calculator where a customer can determine the equity they have in a facility. Screen shots 160-280 include links, selectable by a customer, where the customer can access screens (not shown) which show further examples and descriptions for the particular financing product.

FIGS. 15 and 16 are one exemplary embodiment of an interface screen 300 to an equity valuation tool. In order for the tool to produce an equity valuation of a facility, in the embodiment shown, a power generation facility, the customer enters data relating to the plant, for example, plant size in Megawatts, a heat rate, a percentage of revenues under contract, a number of years remaining under contract and a remaining term of the debt associated with the plant. In addition, current financing information, for example, an outstanding principal and interest rate, is entered. Referring to FIG. 16, a customer continues to enter information into screen 300 including electricity prices and an annual rate of increase, or projections of prices and projected fuel costs including an escalator. Upon entry of the equity valuation data by a customer, in one embodiment, the customer can choose to submit the data using a button 302 labeled submit in order to submit the customer entered data to the equity valuation tool. In another embodiment, instead of entering values for electricity prices and fuel costs, the customer may select to use default values, stored within system 10, for electricity prices and fuel costs. In the embodiment shown in FIG. 16, default values are selected using a check box.

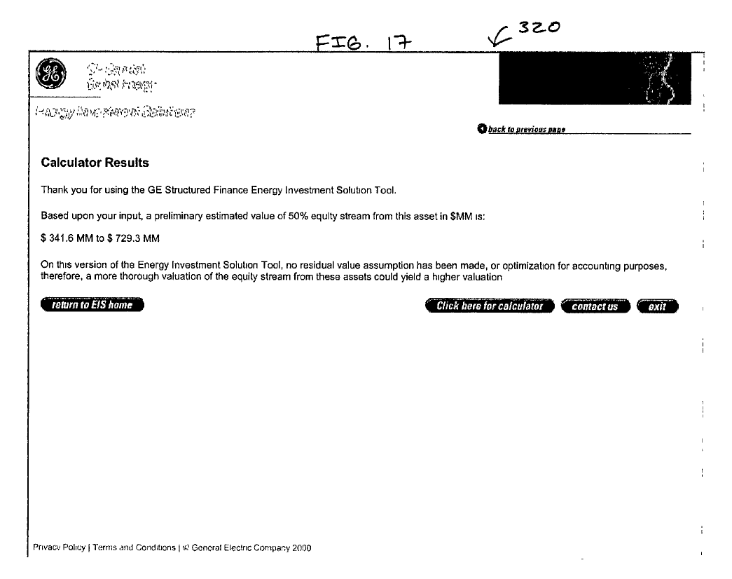

FIG. 17 is one embodiment of a screen shot 320 showing the results of a submitted equity valuation which has been calculated using the equity valuation tool accessed using interface screen 300 (shown in FIGS. 15 and 16). As shown in the Figure, an equity valuation is displayed to the customer based upon their input into the tool. Selection of a link 322 allows the customer to return to the valuation tool interface screen 300, if they should desire to revise one or more of the inputs into the valuation tool to produce a different equity valuation.

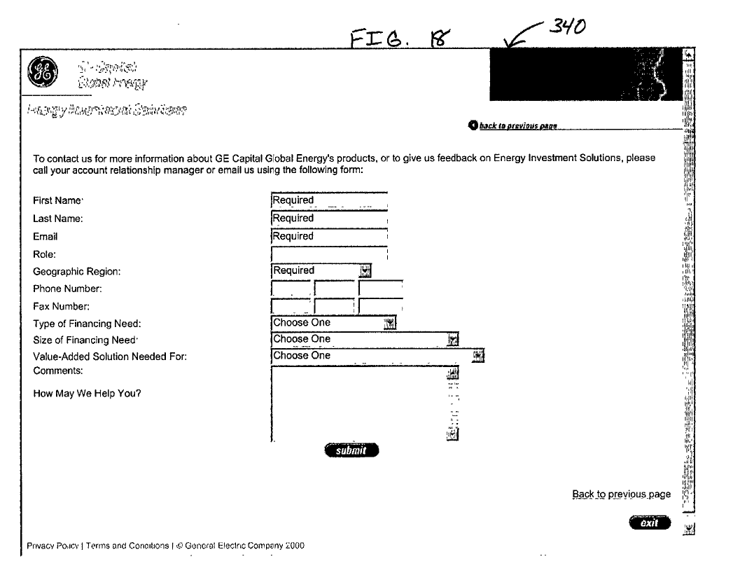

FIG. 18 is a screen shot 340 presented to a user who has indicated through one of the previously described screen shots, that they would like to be contacted regarding financing of their project. Included in the embodiment shown on screen shot 340 are a name, E-mail address, title, geographic region, telephone na facsimile numbers, financing type, the size of the financing, what the financing is for and a comments area.

The above described system facilitates financing requirements in that a customer can readily select, via the system, multiple financing products for review without requiring involvement of the lender. Such selections can be made by the customer any time, anywhere, at the customer's convenience. Further, the system provides screening to maximize efficiency of time use by both potential customer and lender. Submission of customer data for further contact is at the customer's discretion. The lenders resources are freed up because less time is spent chasing down dead ends, example, customers who are not serious about pursuing financing options.

While the invention has been described in terms of various specific embodiments, those skilled in the art will recognize that the invention can be practiced with modification within the spirit and scope of the claims.

1. A method for operating a computer to facilitate a choice of a financing product, said method comprising the steps of:
prompting a customer to provide information related to a financing requirement;
determining a proper financing product based upon provided information; and
prompting the customer with a recommendation for a financing product.

2. A method according to claim 1 further comprising the step of displaying a computer generated screen listing a plurality of financing type selections.

3. A method according to claim 2 wherein said financing type selections comprise at least one of project finance, high yield debt, leasing, project common equity, limited partnership, private equity and preferred equity.

4. A method according to claim 3 wherein for a project common equity financing type selection, prompting the customer to provide information comprises the step of displaying a computer generated screen prompting the customer to enter criteria to valuate the equity in their property.

5. A method according to claim 4 wherein the property is a power generation plant, the criteria requested being at least one of power plant information, current financing information, projected electricity prices and projected fuel costs.

6. A method according to Claim S wherein default values are available for at least one of projected electricity prices and projected fuel costs, when specific values are not provided.

7. A method according to claim 3 further comprising the step of displaying a computer generated screen describing a selected financing type.

8. A method according to claim 1, wherein prompting the customer to provide information comprises the steps of:
displaying a computer generated screen listing a plurality of background questions relating to the financing requirement; and
displaying a computer generated screen listing a plurality of financing specific questions.

9. A method according to claim 8, wherein the background questions relating to the financing requirement comprise at least one of the country where financing is required, which energy related business is the financing for, is the financing required for an operating asset, are U.S. taxes currently being paid by the customer, is the customer interested in either of off-balance sheet or non-recourse financing, and is the customer interested in structured debt such as high yield debt or subordinated debt.

10. A method according to claim 8, wherein the financing specific questions comprise at least one of amount of financing, selling or optimizing equity position, willing to share control, upside potential and residuals of the asset, willing to subordinate equity distribution to a preferred equity investor, willing to be contacted regarding the financing, early stage pre-IPO company or company in early stage of corporate cycle and interested in financing senior to common equity but junior to lenders and trade creditors.

11. A computer programmed to:
prompt a customer to provide information related to a financing requirement;
determine a proper financing product for the customer; and
prompt the customer with an inquiry as to whether they wish to pursue financing opportunities.

12. A computer according to claim 11 further programmed to display a computer generated screen listing a plurality of financing type selections.

13. A computer according to claim 12 wherein said financing type selections comprise at least one of project finance, high yield debt, leasing, project common equity, limited partnership, private equity and preferred equity.

14. A computer according to claim 13 wherein for a project common equity financing type selection, said computer displays, to the customer, a prompt to enter criteria to valuate the equity in their property.

15. A computer according to claim 14 wherein the prompt is an interface to a valuation tool for power generation plants, the criteria requested being at least one of power plant information, current financing information, projected electricity prices and projected fuel costs.

16. A computer according to claim 15 wherein default values for at least one of projected electricity prices and projected fuel costs are available.

17. A computer according to claim 13, whereupon a selection of a financing type by the customer, said computer programmed to display, to the customer, a computer generated screen describing the selected financing type.

18. A computer according to claim 1 1, wherein to prompt the customer to provide information, said computer:
displays a computer generated screen listing a plurality of background questions relating to the financing requirement; and
displays a computer generated screen listing a plurality of financing specific questions upon entry of answers to background questions.

19. A computer according to claim 18, wherein the background questions relating to the financing requirement comprise at least one of the country where financing is required, which energy related business is the financing for, is the financing required for an operating asset, are U.S. taxes currently being paid by the customer, is the customer interested in either of off-balance sheet or non-recourse financing, and is the customer interested in structured debt such as high yield debt or subordinated debt.

20. A computer according to claim 18, wherein the financing specific questions comprise at least one of amount of financing, selling or optimizing equity position, willing to share control, upside potential and residuals of the asset, willing to subordinate equity distribution to a preferred equity investor, willing to be contacted regarding the financing, early stage pre-IPO company or company in early stage of corporate cycle and interested in financing senior to common equity but junior to lenders and trade creditors.

21. A database comprising:
data corresponding to answers to questions relating to a customers financing requirement; and
data corresponding to a recommended financing type for the customer.

22. A database according to claim 21 wherein data corresponding to answers further comprises data corresponding to answers to at least one of background questions and financing specific questions relating to the customers financing requirement.

23. A database according to claim 21 further comprising data corresponding to a valuation of one or more facilities.

24. A database according to claim 23 wherein the facilities are power generation plants.

25. A database according to claim 21 further comprising data corresponding to default values for electricity prices and fuel costs.

26. A database according to claim 21 further comprising data corresponding to a description of available financing types.

27. A system for facilitating financing transactions, said system comprising:
a database comprising data corresponding to available financing type selections; and
a server configured to prompt a customer to type and to prompt the customer provide answers to questions relating to a financing requirement.

28. A system according to claim 27 wherein said database further comprises data corresponding to answers to at least one of background questions and financing specific questions relating to the customers financing requirement.

29. A system according to claim 27 wherein said database further comprises data corresponding to a valuation of one or more facilities.

30. A system according to claim 29 wherein the facilities are power generation plants.

31. A system according to claim 27 wherein said server is configured to cause a screen listing a plurality of available financing type selections to be displayed at a client computer.

32. A system according to claim 31 wherein the financing type selections comprise at least one of project finance, high yield debt, leasing, project common equity, limited partnership, private equity and preferred equity.

33. A system according to claim 32 wherein for a project common equity financing type, said server causes to be displayed at a client computer a screen prompting the customer to enter criteria to valuate the equity in their facility.

34. A system according to claim 33 wherein said server is configured to generate a valuation of equity in a facility based upon customer entered criteria.

35. A system according to claim 33 wherein the valuation criteria includes at least one of the plant size, a heat rate, a percentage of revenues under contract, a number of years remaining under contract, a remaining term of the existing debt, an outstanding principal, interest rate, electricity prices and an annual rate of increase, and projections of prices and projected fuel costs including an escalator.

36. A system according to claim 35 wherein said database further comprises data corresponding to default values for electricity prices and projected fuel costs.

37. A system according to claim 36 wherein said server is configured to use default values for at least one of electricity prices and projected fuel costs based upon customer entered valuation criteria.

38. A method for initiating a financing transaction for a facility, said method comprising the steps of:
selecting, from an electronic interface, a financing type;
entering, into the electronic interface, contact information and information regarding the financing transaction; and
requesting, from the electronic interface, a further contact regarding the financing.

39. A method according to claim 38 wherein the financing types comprise at least one of project finance, high yield debt, leasing, project common equity, limited partnership, private equity and preferred equity.

40. A method according to claim 38 wherein for a project common equity financing type, said method further comprises the step of entering, into the electronic interface, criteria for valuation of the facility.

41. A method according to claim 40 wherein criteria for valuation of the facility comprises at least one of the plant size, a heat rate, a percentage of revenues under contract, a number of years remaining under contract, a remaining term of the existing debt, an outstanding principal, interest rate, electricity prices and an annual rate of increase, and projections of prices and projected fuel costs including an escalator.

42. A method for determining a proper financing type for a facility, said method comprising the steps of:
entering, into an electronic interface, answers to background questions and answers to financing specific questions regarding the financing requirement; and
requesting, from the electronic interface, a financing type recommendation.

43. A method according to claim 42 wherein the background questions comprises at least one of the country where financing is required, which energy related business is the financing for, is the financing required for an operating asset, are U.S. taxes currently being paid by the customer, is the customer interested in either of off-balance sheet or non-recourse financing, and is the customer interested in structured debt such as high yield debt or subordinated debt.

44. A method according to claim 42 wherein the financing specific questions comprise at least one of amount of financing, selling or optimizing equity position, willing to share control, upside potential and residuals of the asset, willing to subordinate equity distribution to a preferred equity investor, willing to be contacted regarding the financing, early stage pre-IPO company or company in early stage of corporate cycle and interested in financing senior to common equity but junior to lenders and trade creditors.

45. Apparatus comprising:
means for prompting a customer to select a financing type;
means for prompting the customer to provide information related to a financing requirement; and
means for prompting the customer with an inquiry as to whether they wish to pursue financing opportunities.

46. Apparatus according to claim 45 wherein said means for prompting a customer to select a financing type comprises means for displaying a computer generated screen listing a plurality of financing types.

47. Apparatus according to claim 46 wherein said financing types comprise at least one of project finance, high yield debt, leasing, project common equity, limited partnership, private equity and preferred equity.

48. Apparatus according to claim 47 wherein for project common equity, said means for prompting the customer to provide information displays a computer generated screen prompting the customer to enter information for a valuation of a facility.

49. Apparatus according to claim 48 wherein information for valuation of a facility comprises at least one of the plant size, a heat rate, a percentage of revenues under contract, a number of years remaining under contract, a remaining term of the existing debt, an outstanding principal, interest rate, electricity prices and an annual rate of increase, and projections of prices and projected fuel costs including an escalator.

50. Apparatus according to claim 49 wherein information for valuation of a facility comprises default values for at least one of electricity prices and projected fuel prices.

51. Apparatus according to claim 45 wherein said means for prompting the customer to provide information comprises means for displaying a computer generated screen listing a plurality of questions, including at least one of background questions and financing specific questions relating to the customers financing requirement.

52. Apparatus according to claim 51 wherein the background questions comprise at least one of the country where financing is required, which energy related business is the financing for, is the financing required for an operating asset, are U.S. taxes currently being paid by the customer, is the customer interested in either of off-balance sheet or non-recourse financing, and is the customer interested in structured debt such as high yield debt or subordinated debt.

53. Apparatus according to claim 51 wherein the financing specific questions comprise at least one of amount of financing, selling or optimizing equity position, willing to share control, upside potential and residuals of the asset, willing to subordinate equity distribution to a preferred equity investor, willing to be contacted regarding the financing, early stage pre-IPO company or company in early stage of corporate cycle and interested in financing senior to common equity but junior to lenders and trade creditors.

54. A system for facilitating financing transactions for one or more power generation plants, said system comprising:
a database comprising data corresponding to available financing type selections for power generation plants; and
a server configured to prompt a customer to provide answers to questions relating to power generation plant financing requirements.

55. A system according to claim 58 wherein said database further comprises data corresponding to answers to at least one of background questions and financing specific questions relating to the customers financing requirement.

56. A system according to claim 58 wherein said server is configured to cause a screen listing a plurality of available financing type selections to be displayed at a client computer.

57. A system according to claim 60 wherein the financing type selections comprise at least one of project finance, high yield debt, leasing, project common equity, limited partnership, private equity and preferred equity.

58. A system according to claim 61 wherein for a project common equity financing type, said server causes to be displayed at a client computer a screen prompting the customer to enter criteria to valuate the equity in their power generation plants.

59. A system according to claim 62 wherein said server is configured to generate a valuation of equity in one or more power generation plants based upon customer entered criteria.

60. A system according to claim 62 wherein the valuation criteria for the power generation plants includes at least one of the plant size, a heat rate, a percentage of revenues under contract, a number of years remaining under contract, a remaining term of the existing debt, an outstanding principal, interest rate, electricity prices and an annual rate of increase, and projections of prices and projected fuel costs including an escalator.

61. A computer-readable medium, comprising:
a record of customer submitted facility data;
a plurality of rules for calculating equity in a facility, based upon customer submitted data; and
a record of results from applying said rules to the customer submitted data.

62. A computer-readable medium according to claim 65 wherein said rules for calculating equity comprise rules based upon at least one of plant size, a heat rate, a percentage of revenues under contract, a number of years remaining under contract, a remaining term of the existing debt, an outstanding principal, interest rate, electricity prices and an annual rate of increase, and projections of prices and projected fuel costs including an escalator.

63. A computer-readable medium according to claim 65 comprising a record of financing type selections comprising at least one of project finance, high yield debt, leasing, project common equity, limited partnership, private equity and preferred equity.
